(19) United States
(12) Patent Application Publication
(10) Pub. No.: US 2021/0339508 A1
(43) Pub. Date: Nov. 4, 2021

(54) METHOD FOR MANUFACTURING A LAMINATE WHICH COMPRISES ELECTRONIC COMPONENTS AND/OR FUNCTIONAL UNITS

(71) Applicant: Covestro Intellectual Property GmbH & Co. KG, Leverkusen (DE)

(72) Inventors: Georgios TZIOVARAS, Neuss (DE); Helge KOSTHORST, Visselhövede (DE); Theivanayagam DEIVARAJ, Dusseldorf (DE); Norbert HERMANNS, Krefeld (DE); Heinz PUDLEINER, Krefeld (DE)

(21) Appl. No.: 17/273,335

(22) PCT Filed: Sep. 10, 2019
(86) PCT No.: PCT/EP2019/074031

§ 371 Date: Mar. 4, 2021

(30) Foreign Application Priority Data
Sep. 14, 2018 (EP) 18194381.2

(51) Int. Cl. B32B 27/06; B32B 5/18; B32B 27/40; B32B 37/18

(52) U.S. Cl. CPC B32B 27/065; B32B 5/18; B32B 27/40; B32B 2457/20; B32B 2266/0278; B32B 2307/536; B32B 2425/00; B32B 37/182

(57) ABSTRACT

The present invention relates to a laminate comprising at least one layer a) containing at least one thermoplastic and/or thermosetting plastic, at least one layer b) containing at least one thermoplastic polyurethane and at least one component and/or a functional unit (A) which is positioned on the at least one layer a), and wherein the least regions of the at least one thermoplastic polyurethane of layer b) are designed as a foam layer. The invention also relates to a method for manufacturing such a laminate and to the use of the laminate for manufacturing security documents, preferably identification documents, smart card smartphones, tablets, displays for smartphones, and/or displays for tablets.

The present invention relates to a laminate comprising at least one layer a) containing at least one thermoplastic and/or thermoset, at least one layer b) containing at least one thermoplastic polyurethane and at least one component and/or a functional unit (A) positioned atop the at least one layer a), and wherein the at least one thermoplastic polyurethane of layer b) takes the form of a foam layer at least in some regions. The invention further relates to a process for producing such a laminate and to the use of the laminate for production of security documents, preferably identification documents and chip cards.

The incorporation of all kinds of electronic components into flat and two-dimensional structures is common practice, and it is to be expected that it will become ever more important in future to incorporate sensitive electronic components into particularly thin two-dimensional structures. For instance, such electronic components may be present in labels, mobile phones, smartwatches or chip cards. Particular mention should be made of chip cards, also called smartcards. Such cards generally contain an electronic printed circuit board equipped with sensitive electronic components. These usually sensitive electronic components must be sufficiently protected for them not to be damaged in day-to-day use. With decreasing thickness of the electronic components for various applications, customary assembly methodologies, such as screw connection, snap-fitting of the front and back parts of the housing, are becoming increasingly complex nowadays and costly to manufacture. The lamination method, which is nowadays used predominantly in the manufacture of smartcards and security documents, could also be used in future for the embedding of electronic components into other electronic devices. Such other electronic devices may be smartphones, displays, navigation devices, smartwatches, games consoles and other articles.

A customary manufacturing method for embedding and protection of sensitive electronic components is casting in polyurethane or in epoxy resins. It is possible here to adjust the hardness, thickness and color of the system as desired. A disadvantage, however, is that, especially in the case of thin layers below 1 mm, the uniformity of layer thickness and the surface characteristics are very complex or uncontrollable.

WO-A 2006/101493 describes a complex process for the embedding of electronic components in thin layers of smartcards. Here, the outer films of a smartcard are positioned in a corresponding mold, the electronic components are positioned between the films, the mold is closed and then a resin system is injected between the films. This methodology is complex, complicated and costly; moreover, it requires completely new manufacturing systems to produce such cards. A disadvantage of this method is that the customary lamination method for card production is not used here. Therefore, the inexpensive production of large numbers of items is possible only with difficulty by this method.

A further method for the production of identification cards is the injection molding method, which is disclosed, for example, in WO-A 98/52731. It is possible thereby, by comparison with ambient-pressure casting, to define and maintain the layer thickness and surface characteristics. The disadvantage here is the high pressure and the temperature with which the liquid plastic flows over the electronic components. This makes this method unsuitable for the embedding of electronic components. DE-A 19921678 discloses a combination of injection molding methods with subsequent mechanical processing of the cards.

A further process for production of identification cards is the injection molding of thin housing parts containing depressions which correspond to the structure of the electronic components to be embedded, and is disclosed in DE-A 102007016779 and WO-A 2016/139114. The electronic components may then be inserted into these depressions. In the production of cards comprising electronic components, the lamination of the individual layers is typically preceded by stamping of corresponding openings into the individual film layers, which form space for the electronic components and are not destroyed in the laminating operation. This is disclosed in DE 43 43 206 A1.

A disadvantage of the processes described above is an additional assembly step for provision of a suitable opening in order that the electronic components can be introduced into the layer composite or laminate. If no liquid adhesive is poured in advance, there is no full-area bond of the electronic components to the individual layers and hence a reduced protective function of the electronic components.

WO-A 2012/084859 discloses the embedding of thin two-dimensional electronic components into a thermoplastic foam, wherein a barrier film surrounds the foam layer and the electronic component. This barrier film is bonded to the foam layer via a weld seam in some regions. The weld seam features high integrity and exceptional mechanical stability. The weld seam is obtained by means of a pressure of ≥50 to ≤150 bar at a temperature of ≥100 to ≤200° C.

It was an object of the present invention to provide a laminate containing a component and/or a functional unit, wherein the ability of said component and/or functional unit to function is not impaired or even destroyed in the production of the laminate. It was a further object of the present invention to provide a process for producing such laminates.

It has been found that, surprisingly, this object is achieved by a laminate comprising
at least one layer a) containing at least one thermoplastic and/or thermoset, preferably a thermoplastic,
at least one layer b) containing at least one thermoplastic polyurethane,
   wherein at least one component and/or one functional unit (A) is positioned on the at least one layer a), and wherein the at least one thermoplastic polyurethane of layer b) takes the form of a foam layer at least in some regions.

It is a feature of the laminate of the invention that the component and/or functional unit (A) embedded is very substantially protected from slips and hence from damage in the laminating operation. Moreover, simple embedding of the component and/or the functional unit (A) into the laminate is effected, such that these laminates can also be produced in a large number. Moreover, the laminate of the invention features a flat, smooth surface.

What is meant by “laminate” in the context of this invention is at least two superposed layers, preferably plastic layers, more preferably thermoplastic and or thermoset layers, most preferably thermoplastic layers. More particularly, these layers may be provided in the form of plastic films, preferably in the form of thermoplastic and/or thermoset films, more preferably thermoplastic films. These layers may be intimately bonded under the action of pressure and temperature. Typically, temperatures of ≥80° C. to ≤220° C., preferably of ≥100° C. to ≤200° C., most preferably of ≥110° C. to ≤190° C., and a pressure of ≥2 N/cm² to ≤400 N/cm², preferably of ≥5 N/cm² to ≤350 N/cm², most preferably of ≥10 N/cm² to ≤300 N/cm², are used in the laminating operation.

The laminate preferably has a thickness after the laminating operation within a range from ≥80 to ≤2000 μm, preferably from ≥200 to ≤1500 μm, more preferably from ≥350 to ≤1000 μm, most preferably of ≥400 to ≤800 μm. The laminate preferably has a length after the laminating operation within a range from ≥0.1 cm to ≤100 m, preferably from ≥0.2 cm to ≤50 m, more preferably from ≥1 cm to ≤1 m, most preferably from ≥5 cm to ≤50 cm. The laminate preferably has a width after the laminating operation within a range from ≥0.1 cm to ≤100 m, preferably from ≥0.2 cm to ≤50 m, more preferably from ≥1 cm to ≤1 m, most preferably from ≥5 cm to ≤50 cm.

The laminate preferably has an area, calculated from the length and width of the laminate, after the laminating operation within a range from ≥0.1 cm² to ≤2000 m², preferably from ≥1 cm² to ≤1000 m², more preferably from ≥5 cm² to ≤100 mm², most preferably from ≥10 cm² to ≤10 m², further preferably from ≥20 cm² to ≤1 m². The aspect ratio of length or width to thickness is preferably within a range from 10:1 to 1000:1, more preferably within a range from 20:1 to 500:1.

The difference in thickness between the thinnest point in the laminate compared to the thickest point in the laminate over the total length and total width of the laminate is preferably within a range from 1 to 150 μm, more preferably within a range from 2 to 80 μm, especially preferably within a range from 5 to 70 μm.

The difference in thickness can be ascertained by means of a micrometer screw that can preferably measure 0.1 μm as the smallest measurement unit. In order to reach measurement sites far from the outer edges, the laminate can be cut close to the measurement site and then measured with the micrometer screw.

Preferably, the at least one component and/or functional unit (A) is surrounded by the at least one layer b) at least in regions or the at least one component and/or functional unit is preferably fully encased by the at least one layer b), and the at least one component and/or functional unit is preferably fully encased by the at least one layer b).

What is meant by “encased” is that the component and/or functional unit (A) is fully covered and/or surrounded by layer b).

It is possible for any number of components and/or functional units (A) to be included in the laminate. It is also conceivable that sensors, chip cards, data storage media, batteries, illumination units and/or else components and/or functional units (A) connected to one another may be used. Component and/or functional unit (A) may have thicknesses in the range from 20 μm to 1500 μm.

The at least one layer a) contains at least one thermoplastic and/or thermoset, preferably a thermoplastic. The thermoplastic of the at least one layer a) may preferably be at least one plastic selected from polymers of ethylenically unsaturated monomers and/or polycondensates of difunctional reactive compounds and/or polyaddition products of difunctional reactive compounds or mixtures thereof. For certain applications it may be advantageous and hence preferable to use at least one transparent thermoplastic. The thermoset may be at least one plastic selected from polymers of ethylenically unsaturated monomers and/or polycondensates of trifunctional reactive compounds and/or polyaddition products of trifunctional reactive compounds or mixtures thereof. These are, for example, curable molding compounds, formaldehyde molding compounds, for example phenolic resins, phenol-formaldehyde (PF), cresol-formaldehyde (CF), resorcinol-formaldehyde (RF), xylenol-formaldehyde (XF) resins, amino resins, for example urea-formaldehyde (UF), melamine-formaldehyde (MF), furan-formaldehyde (FF) resins, and further compositions such as prepregs, unsaturated polyester resins (UP), vinyl ester resins (VE), phenacrylate resins (PHA), epoxy resins (EP), diallyl phthalate resins and/or polydiallylphthalate (PDAP) resins, silicone resin (Si).

Particularly suitable thermoplastics of layer a) are polycarbonates or copolycarbonates based on diphenols, poly- or copolyacrylates and poly- or copolymethacrylates, for example and with preference polymethylmethacrylate (PMMA), poly- or copolymers with styrene, for example and with preference polystyrene (PS), acrylonitrile-butadiene-styrene (ABS) or polystyrene-acrylonitrile (SAN), thermoplastic polyurethanes, and polyolefins, for example and with preference polypropylene grades or polyolefins based on cyclic olefins (for example TOPAS™), poly- or copolycondensates of an aromatic dicarboxylic acid and aliphatic, cycloaliphatic and/or araliphatic diols having 2 to 16 carbon atoms, for example and with preference poly- or copolycondensates of terephthalic acid, particularly preferably poly- or copolyethylene terephthalate (PET or CoPET), glycol-modified PET (PETG), glycol-modified poly- or copolycyclohexanedimethylene terephthalate (PCTG) or poly- or copolybutylene terephthalate (PBT or CoPBT), preferably poly- or copolycondensates of naphthalenedicarboxylic acid, particularly preferably polyethylene glycol naphthalate (PEN), poly- or copolycondensate(s) of at least one cycloalkyldicarboxylic acid, for example and with preference polycyclohexanedimethanolcyclohexanedicarboxylic acid (PCCD), polysulfones (PSU), polyvinyl halides, for example and with preference polyvinyl chloride (PVC), or mixtures thereof or blends of at least two of the above, more preferably one or more polycarbonates or copolycarbonates based on diphenols, poly- or copoly(meth)acrylates, poly- or copolycondensates of terephthalic acid or mixtures thereof or blends of at least two of the above.

Particularly preferred thermoplastics are one or more polycarbonate(s) or copolycarbonate(s) based on diphenols or blends comprising at least one polycarbonate or copolycarbonate. Very particular preference is given to blends containing at least one polycarbonate or copolycarbonate and at least one poly- or copolycondensate of terephthalic acid, of naphthalenedicarboxylic acid or of a cycloalkyldicarboxylic acid, preferably of cyclohexanedicarboxylic acid. Very particular preference is given to polycarbonates or copolycarbonates, especially having average molecular weights Mw of 500 to 100 000, preferably of 10 000 to 80 000, more preferably of 15 000 to 40 000, or blends thereof with at least one poly- or copolycondensate of terephthalic acid having average molecular weights Mw of 10 000 to 200 000, preferably of 21 000 to 120 000.

Suitable poly- or copolycondensates of terephthalic acid in preferred embodiments of the invention are polyalkylene terephthalates. Suitable polyalkylene terephthalates are, for example, reaction products of aromatic dicarboxylic acids or their reactive derivatives (for example dimethyl esters or anhydrides) and aliphatic, cycloaliphatic or araliphatic diols and mixtures of these reaction products.

Preferred polyalkylene terephthalates can be prepared from terephthalic acid (or reactive derivatives thereof) and aliphatic or cycloaliphatic diols having 2 to 10 C atoms by known methods (Kunststoff-Handbuch [Plastics Handbook], vol. VIII, p. 695 ff, Karl-Hanser-Verlag, Munich 1973).

Preferred polyalkylene terephthalates contain at least 80 mol %, preferably 90 mol %, of terephthalic acid radicals, based on the dicarboxylic acid component, and at least 80 mol %, preferably at least 90 mol %, of ethylene glycol and/or butane-1,4-diol and/or cyclohexane-1,4-dimethanol radicals based on the diol component.

The preferred polyalkylene terephthalates may contain, in addition to terephthalic acid radicals, up to 20 mol % of radicals of other aromatic dicarboxylic acids having 8 to 14 carbon atoms or of aliphatic dicarboxylic acids having 4 to 12 carbon atoms, such as for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

The preferred polyalkylene terephthalates may contain, in addition to ethylene and/or butane-1,4-diol glycol radicals, up to 80 mol % of other aliphatic diols having 3 to 12 carbon atoms or of cycloaliphatic diols having 6 to 21 carbon atoms, for example radicals of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol and 2-ethylhexane-1,6-diol, 2,2-diethylpropane-1,3-diol, hexane-2,5-diol, 1,4-di([beta]-hydroxyethoxy)benzene, 2,2-bis(4-hydroxycyclohexyl)propane, 2,4-dihydroxy-1,1,3,3-tetramethylcyclobutane, 2,2-bis (3-[beta]-hydroxyethoxyphenyl)propane and 2,2-bis(4-hydroxypropoxyphenyl)propane (cf. DE-A 24 07 674, 24 07 776, 27 15 932).

The polyalkylene terephthalates may be branched by incorporation of relatively small amounts of tri- or tetrahydric alcohols or tri- or tetrabasic carboxylic acids, as described for example in DE-OS 19 00 270 and US-PS 3 692 744. Examples of preferred branching agents are trimesic acid, trimellitic acid, trimethylolethane and trimethylolpropane and pentaerythritol.

It is preferable when not more than 1 mol % of the branching agent is used, based on the acid component.

Particular preference is given to polyalkylene terephthalates which have been prepared solely from terephthalic acid and the reactive derivatives thereof (e.g. the dialkyl esters thereof) and ethylene glycol and/or butane-1,4-diol and/or cyclohexane-1,4-dimethanol radicals, and to mixtures of these polyalkylene terephthalates.

Preferred polyalkylene terephthalates are also copolyesters prepared from at least two of the abovementioned acid components and/or from at least two of the abovementioned alcohol components; particularly preferred copolyesters are poly(ethylene glycol/butane-1,4-diol) terephthalates.

The polyalkylene terephthalates used with preference as component preferably have an intrinsic viscosity of about 0.4 to 1.5 dl/g, preferably 0.5 to 1.3 dl/g, measured in each case in phenol/o-dichlorobenzene (1:1 parts by weight) at 25° C.

In particularly preferred embodiments of the invention the blend of at least one polycarbonate or copolycarbonate with at least one poly- or copolycondensate of terephthalic acid is a blend of at least one polycarbonate or copolycarbonate with poly- or copolybutylene terephthalate or glycol-modified poly- or copolycyclohexanedimethylene terephthalate. Such a blend of polycarbonate or copolycarbonate with poly- or copolybutylene terephthalate or glycol-modified poly- or copolycyclohexanedimethylene terephthalate may preferably be one comprising 1% to 90% by weight of polycarbonate or copolycarbonate and 99% to 10% by weight of poly- or copolybutylene terephthalate or glycol-modified poly- or copolycyclohexanedimethylene terephthalate, preferably comprising 1% to 90% by weight of polycarbonate and 99% to 10% by weight of polybutylene terephthalate or glycol-modified polycyclohexanedimethylene terephthalate, wherein the proportions add up to 100% by weight. Such a blend of polycarbonate or copolycarbonate with poly- or copolybutylene terephthalate or glycol-modified poly- or copolycyclohexanedimethylene terephthalate may particularly preferably be one comprising 20% to 85% by weight of polycarbonate or copolycarbonate and 80% to 15% by weight of poly- or copolybutylene terephthalate or glycol-modified poly- or copolycyclohexanedimethylene terephthalate, preferably comprising 20% to 85% by weight of polycarbonate and 80% to 15% by weight of polybutylene terephthalate or glycol-modified polycyclohexanedimethylene terephthalate, wherein the proportions add up to 100% by weight. Such a blend of polycarbonate or copolycarbonate with poly- or copolybutylene terephthalate or glycol-modified poly- or copolycyclohexanedimethylene terephthalate may very particularly preferably be one comprising 35% to 80% by weight of polycarbonate or copolycarbonate and 65% to 20% by weight of poly- or copolybutylene terephthalate or glycol-modified poly- or copolycyclohexanedimethylene terephthalate, preferably comprising 35% to 80% by weight of polycarbonate and 65% to 20% by weight of polybutylene terephthalate or glycol-modified polycyclohexanedimethylene terephthalate, wherein the proportions add up to 100% by weight. In very particularly preferred embodiments blends of polycarbonate and glycol-modified polycyclohexanedimethylene terephthalate may be concerned in the compositions mentioned above.

Suitable polycarbonates or copolycarbonates in preferred embodiments are particularly aromatic polycarbonates or copolycarbonates.

The polycarbonates or copolycarbonates may be linear or branched in known fashion.

These polycarbonates can be prepared in a known manner from diphenols, carbonic acid derivatives, optionally chain terminators and optionally branching agents. Details of the production of polycarbonates have been set out in many patent specifications during the last 40 years or so. Reference may be made here merely by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to Dres. U. Grigo, K. Kirchner and P. R. Müller, “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117-299.

Suitable diphenols may be, for example, dihydroxyaryl compounds of the general formula (I)

HO—Z—OH (I)

in which Z is an aromatic radical which has 6 to 34 carbon atoms and may contain one or more optionally substituted aromatic rings and aliphatic or cycloaliphatic radicals or alkylaryls or heteroatoms as bridging elements.

Examples of suitable dihydroxyaryl compounds include: dihydroxybenzenes, dihydroxydiphenyls, bis(hydroxyphenyl)alkane s, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

These and further suitable other dihydroxyaryl compounds are described, for example, in DE-A 3 832 396, FR-A 1 561 518, in H. Schnell, Chemistry and Physics of Polycarbonates, Interscience Publishers, New York 1964, p. 28 ff; p. 102 ff, and in D. G. Legrand, J. T. Bendler, Handbook of Polycarbonate Science and Technology, Marcel Dekker New York 2000, p. 72 ff.

Preferred dihydroxyaryl compounds are, for example, resorcinol, 4,4′-dihydroxydiphenyl, bis(4-hydroxyphenyl)methane, bis(3,5-dimethyl-4-hydroxyphenyl)methane, bis(4-hydroxyphenyl)diphenylmethane, 1,1-bis(4-hydroxyphenyl)-1-phenylethane, 1,1-bis(4-hydroxyphenyl)-1-(1-naphthyl)ethane, 1,1-bis(4-hydroxyphenyl)-1-(2-naphthyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)-1-phenylpropane, 2,2-bis(4-hydroxyphenyl)hexafluoropropane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane, 1,1-bis(3,5-dimethyl-4-hydroxyphenyl)cyclohexane, 1,1-bi s (4-hydroxyphenyl)-4-methylcyclohexane, 1,3-bis[2-(4-hydroxyphenyl)-2-propyl]benzene, 1,1′-bis(4-hydroxyphenyl)-3-diisopropylbenzene, 1,1′-bis(4-hydroxyphenyl)-4-diisopropylbenzene, 1,3-bis[243,5-dimethyl-4-hydroxyphenyl)-2-propyl]benzene, bis(4-hydroxyphenyl) ether, bis(4-hydroxyphenyl) sulfide, bis(4-hydroxyphenyl) sulfone, bis(3,5-dimethyl-4-hydroxyphenyl) sulfone and 2,2′,3,3′-tetrahydro-3,3,3′,3′-tetramethyl-1,1′-spirobi[1H-indene]-5,5′-diol or dihydroxydiphenylcycloalkanes of the formula (Ia)

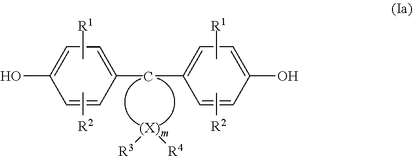

in which
R¹ and R² are independently hydrogen, halogen, preferably chlorine or bromine, C₁-C₈-alkyl, C₅-C₆-cycloalkyl, C₆-C₁₀-aryl, preferably phenyl, and C₇-C₁₂-aralkyl, preferably phenyl-C₁-C₄-alkyl, especially benzyl,
m is an integer from 4 to 7, preferably 4 or 5,
R³ and R⁴ can be chosen individually for each X and are independently hydrogen or C₁-C₆-alkyl and
X denotes carbon,
with the proviso that, on at least one X atom, R³ and R⁴ are both alkyl. Preferably, in the formula (Ia), on one or two X atom(s), especially only on one X atom, R³ and R⁴ are both alkyl.

A preferred alkyl radical for the radicals R³ and R⁴ in formula (Ia) is methyl. The X atoms in alpha position to the diphenyl-substituted carbon atom (C-1) are preferably non-dialkyl-substituted; by contrast, preference is given to alkyl disubstitution in beta position to C-1.

Particularly preferred dihydroxydiphenylcycloalkanes of the formula (Ia) are those having 5 and 6 ring carbon atoms X in the cycloaliphatic radical (m=4 or 5 in formula (Ia)), for example the diphenols of the formulae (Ia-1) to (Ia-3),

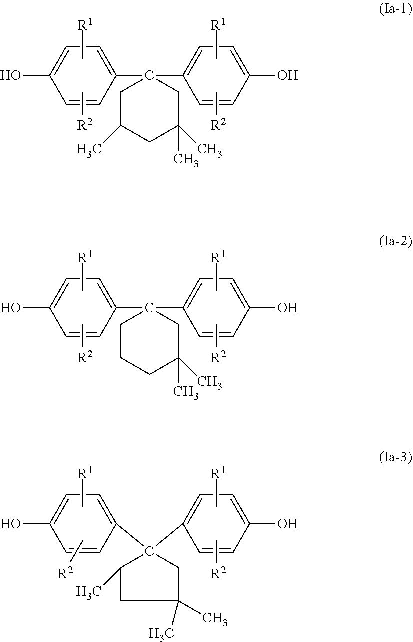

A very particularly preferred dihydroxydiphenylcycloalkane of formula (Ia) is 1,1-bis(4-hydroxyphenyl)-3,3,5-trimethylcyclohexane (formula (Ia-1) with R¹ and R² ═H).

Such polycarbonates can be prepared from dihydroxydiphenylcycloalkanes of formula (Ia) according to EP-A 359 953.

Particularly preferred dihydroxyaryl compounds are resorcinol, 4,4′-dihydroxydiphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis (4-hydroxyphenyl)propane, 2,2-bis(3,5-dimethyl-4-hydroxyphenyl)propane, 1,1-bi s (4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis (4-hydroxyphenyl)-3-diisopropylbenzene and 1,1′-bis(4-hydroxyphenyl)-4-diisopropylbenzene.

Very particularly preferred dihydroxyaryl compounds are 4,4′-dihydroxydiphenyl and 2,2-bis(4-hydroxyphenyl) propane.

It is possible to use either one dihydroxyaryl compound to form homopolycarbonates or different dihydroxyaryl compounds to form copolycarbonates. It is possible to use either one dihydroxyaryl compound of formula (I) or (Ia) to form homopolycarbonates or two or more dihydroxyaryl compounds of formula(e) (I) and/or (Ia) to form copolycarbonates. The various dihydroxyaryl compounds may be interconnected in random or blockwise fashion. In the case of copolycarbonates composed of dihydroxyaryl compounds of formulae (I) and (Ia) the molar ratio of dihydroxyaryl compounds of formula (Ia) to the optionally co-usable other dihydroxyaryl compounds of formula (I) is preferably between 99 mol % of (Ia) to 1 mol % of (I) and 2 mol % of (Ia) to 98 mol % of (I), preferably between 99 mol % of (Ia) to 1 mol % of (I) and 10 mol % of (Ia) to 90 mol % of (I), and especially between 99 mol % of (Ia) to 1 mol % of (I) and 30 mol % of (Ia) to 70 mol % of (I).

A very particularly preferred copolycarbonate can be prepared using 1,1-bis(4-hydroxyphenyl)-3,3,5-trimethylcyclohexane and 2,2-bis(4-hydroxyphenyl)propane dihydroxyaryl compounds of the formulae (Ia) and (I).

Suitable carbonic acid derivatives may, for example, be diaryl carbonates of the general formula (II)

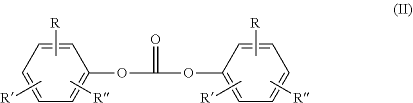

in which
R, R′ and R″ are the same or different and are independently hydrogen, linear or branched C₁-C₃₄-alkyl, C₇-C₃₄-alkylaryl or C₆-C₃₄-aryl, R may additionally also be —COO—R′″ where R′″ is hydrogen, linear or branched C₁-C₃₄-alkyl, C₇-C₃₄-alkylaryl or C₆-C₃₄-aryl.

Preferred diaryl carbonates are for example diphenyl carbonate, methylphenyl phenyl carbonates and di(methylphenyl) carbonates, 4-ethylphenyl phenyl carbonate, di(4-ethylphenyl) carbonate, 4-n-propylphenyl phenyl carbonate, di(4-n-propylphenyl) carbonate, 4-isopropylphenyl phenyl carbonate, di(4-isopropylphenyl) carbonate, 4-n-butylphenyl phenyl carbonate, di(4-n-butylphenyl) carbonate, 4-isobutylphenyl phenyl carbonate, di(4-isobutylphenyl) carbonate, 4-tert-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl) carbonate, 4 isooctylphenyl phenyl carbonate, di(4-isooctylphenyl) carbonate, 4-n-nonylphenyl phenyl carbonate, di(4-n-nonylphenyl) carbonate, 4-cyclohexylphenyl phenyl carbonate, di(4-cyclohexylphenyl) carbonate, 4-(1-methy 1-1-phenylethyl)phenyl phenyl carbonate, di[4-(1-methyl-1-phenylethyl)phenyl] carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl] carbonate, di[4-(2-naphthyl)phenyl] carbonate, 4-phenoxyphenyl phenyl carbonate, di(4-phenoxyphenyl) carbonate, 3-pentadecylphenyl phenyl carbonate, di(3-pentadecylphenyl) carbonate, 4-tritylphenyl phenyl carbonate, di(4-tritylphenyl) carbonate, (methyl salicylate) phenyl carbonate, di(methyl salicylate) carbonate, (ethyl salicylate) phenyl carbonate, di(ethyl salicylate) carbonate, (n-propyl salicylate) phenyl carbonate, di(n-propyl salicylate) carbonate, (isopropyl salicylate) phenyl carbonate, di(isopropyl salicylate) carbonate, (n-butyl salicylate) phenyl carbonate, di(n-butyl salicylate) carbonate, (isobutyl salicylate) phenyl carbonate, di(isobutyl salicylate) carbonate, (tert-butyl salicylate) phenyl carbonate, di(tert-butyl salicylate) carbonate, diphenyl salicylate) carbonate and di(benzyl salicylate) carbonate.

Particularly preferred diaryl compounds are diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl] carbonate and di(methyl salicylate) carbonate. Diphenyl carbonate is very particularly preferred.

It is possible to use either one diaryl carbonate or different diaryl carbonates.

For control or variation of the end groups, it is additionally possible to use, for example, one or more monohydroxyaryl compound(s) as chain terminators that were not used for preparation of the diaryl carbonate(s) used. These may be those of the general formula (III)

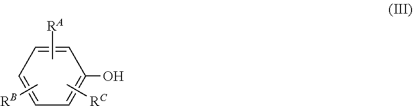

where
R^{A} is linear or branched C₁-C₃₄-alkyl, C₇-C₃₄-alkylaryl, C₆-C₃₄-aryl or —COO—R^{D} where R^{D} is hydrogen, linear or branched C₁-C₃₄-alkyl, C₇-C₃₄-alkylaryl or C₆-C₃₄-aryl and
R^{B}, R^{C} are the same or different and are independently hydrogen, linear or branched C₁-C₃₄-alkyl, C₇-C₃₄-alkylaryl or C₆-C₃₄-aryl.

Such monohydroxyaryl compounds are, for example, 1-, 2- or 3-methylphenol, 2,4-dimethylphenol 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

Preference is given to 4-tert-butylphenol, 4-isooctylphenol and 3-pentadecylphenol.

Suitable branching agents include compounds having three or more functional groups, preferably those having three or more hydroxyl groups.

Suitable compounds having three or more phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1, 1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol and tetra(4-hydroxyphenyl)methane.

Other suitable compounds having three or more functional groups are, for example, 2,4-dihydroxybenzoic acid, trimesic acid/trimesoyl trichloride, cyanuric trichloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The at least one layer b) containing at least one thermoplastic polyurethane takes the form of a foam layer at least in some regions.

It is possible in principle to foam any thermoplastic polyurethanes (TPU) by addition of suitable blowing agents. Preference is given in accordance with the invention to choosing those TPUs that have a low hardness. This minimizes the risk of damage to the electronic components in the course of laminating. The preferably thermoplastic polyurethanes have a hardness of ≥60 Shore A to DIN ISO 7619-1 to ≤60 Shore D to DIN ISO 7619-1, preferably of ≥70 Shore A to DIN ISO 7619-1 to ≤95 Shore A to DIN ISO 7619-1, most preferably of ≥80 Shore A to DIN ISO 7619-1 to ≤95 Shore A to DIN ISO 7619-1.

The at least one layer b) prior to the lamination preferably has a density of ≥0.1 to ≤1.1 g/cm³, more preferably of ≥0.2 to ≤0.9 g/cm³, preferably of ≥0.3 to ≤0.8 g/cm³, especially preferably of ≥0.5 to ≤0.7 g/cm³. The pores in the at least one layer b) prior to lamination preferably have diameters between 10 and 500 μm, more preferably between 50 and 250 μm.

After the lamination, the foam structure in layer b) can break down completely owing to the compression pressure during the compression. The degree of compression before the breakdown of the foam depends on the height of the components that are to be accommodated in the foam layer. Preferably, the height of the components is not greater than the thickness of the foam layer prior to the compression. This can achieve the effect that the component does not project out of the foam layer of the laminate after the lamination and hence is protected by a remaining portion of the foam layer.

TPUs are of great industrial importance because of their good mechanical properties and thermoplastic processability. There is an overview of the production, properties and applications of TPUs, for example, in Kunststoff Handbuch [G. Becker, D. Braun], volume 7 “Polyurethane” [Polyurethanes], Munich, Vienna, Carl Hanser Verlag, 1983.

Depending on the organic diisocyanates used, TPUs can have aliphatic or aromatic character. TPUs typically have a block or segment construction. A basic distinction is made between hard segments and soft segments. Hard segments are formed from the organic diisocyanates used for reaction and short-chain compounds having two to three hydroxyl, amino, thiol or carboxyl groups, preferably compounds having two hydroxyl, amino, thiol or carboxyl groups, more preferably diols, having an average molecular weight of 60 to 500 g/mol. Soft segments are formed from the organic diisocyanates used for reaction and long-chain compounds having two to three hydroxyl, amino, thiol or carboxyl groups, preferably compounds having two hydroxyl, amino, thiol or carboxyl groups, more preferably diols, having an average molecular weight of ≥500 and ≤5000.

Hard segments contribute strength and upper use temperatures to the profiles of properties of the TPUs; soft segments contribute elastic properties and cold flexibility to the material properties of the TPUs.

Both for the hard segments and for the soft segments, organic diisocyanates used may be aromatic, aliphatic, araliphatic, heterocyclic and cycloaliphatic diisocyanates or mixtures of these diisocyanates (cf. HOUBEN-WEYL “Methoden der organischen Chemie” [Methods of Organic Chemistry], Volume E20 “Makromolekulare Stoffe” [Macromolecular Materials], Georg Thieme Verlag, Stuttgart, New York 1987, pp. 1587-1593 or Justus Liebigs Annalen der Chemie, 562, pages 75 to 136).

Specific examples include: aliphatic diisocyanates such as hexamethylene diisocyanate, cycloaliphatic diisocyanates such as isophorone diisocyanate, cyclohexane 1,4-diisocyanate, 1-methylcyclohexane 2,4-diisocyanate and 1-methylcyclohexane 2,6-diisocyanate and the corresponding isomer mixtures, dicyclohexylmethane 4,4′-diisocyanate, dicyclohexylmethane 2,4′-diisocyanate and dicyclohexylmethane 2,2′-diisocyanate and the corresponding isomer mixtures, aromatic diisocyanates such as tolylene 2,4-diisocyanate, mixtures of tolylene 2,4-diisocyanate and tolylene 2,6-diisocyanate, diphenylmethane 4,4′-diisocyanate, diphenylmethane 2,4′-diisocyanate and diphenylmethane 2,2′-diisocyanate, mixtures of diphenylmethane 2,4′-diisocyanate and diphenylmethane 4,4′-diisocyanate, urethane-modified liquid diphenylmethane 4,4′-diisocyanates and diphenylmethane 2,4′-diisocyanates, 4,4′-diisocyanato-1,2-diphenylethane and naphthylene 1,5-diisocyanate. Preference is given to using hexamethylene 1,6-diisocyanate, isophorone diisocyanate, dicyclohexylmethane 4,4′-diisocyanate, diphenylmethane diisocyanate isomer mixtures having a diphenylmethane 4,4′-diisocyanate content of >96% by weight and especially diphenylmethane 4,4′-diisocyanate and naphthylene 1,5-diisocyanate. These diisocyanates can be used individually or in the form of mixtures with one another. They can also be used together with up to 15% by weight (based on the total amount of diisocyanate) of a polyisocyanate, for example triphenylmethane 4,4′,4″-triisocyanate or polyphenylpolymethylene polyisocyanates. Particularly preferred organic diisocyanates are, for example, diphenylmethane 4,4′-diisocyanate, hydrogenated diphenylmethane 4,4′-diisocyanate, toluene 2,4-diisocyanate and hexamethylene diisocyanate.

The preferred short-chain diols having a molecular weight of 60 to 500 g/mol are preferably aliphatic diols having 2 to 14 carbon atoms, for example ethanediol, propane-1,2-diol, propane-1,3-diol, butane-1,4-diol, butane-2,3-diol, pentane-1,5-diol, hexane-1,6-diol, diethylene glycol and dipropylene glycol. Also suitable, however, are diesters of terephthalic acid with glycols having 2 to 4 carbon atoms, for example bis(ethylene glycol) terephthalate or bis(butane-1,4-diol) terephthalate, hydroxyalkylene ethers of hydroquinone, for example 1,4-di(β-hydroxyethyl)hydroquinone, ethoxylated bisphenols, for example 1,4-di(β-hydroxyethyl)bisphenol A, (cyclo)aliphatic diamines, such as isophoronediamine, ethylenediamine, propylene-1,2-diamine, propylene-1,3-diamine, N-methylpropylene-1,3-diamine, N,N′-dimethylethylenediamine and aromatic diamines such as tolylene-2,4-diamine, tolylene-2,6-diamine, 3,5-diethyltolylene-2,4-diamine or 3,5-diethyltolylene-2,6-diamine or primary mono-, di-, tri- or tetraalkyl-substituted 4,4′-diaminodiphenylmethanes. Particular preference is given to using ethanediol, propane-1,2-diol, propane-1,3-diol, butane-1,4-diol, hexane-1,6-diol, ethylene glycol, diethylene glycol, 1,4-di(β-hydroxyethyl)hydroquinone or 1,4-di(β-hydroxyethyl)bisphenol A. It is also possible to use mixtures of the abovementioned compounds. In addition, it is also possible to add relatively small amounts of triols.

The long-chain compounds having two to three hydroxyl, amino, thiol or carboxyl groups, preferably compounds having two hydroxyl, amino, thiol or carboxyl groups, more preferably diols, having a number-average molecular weight of ≥500 and ≤5000 may be divided into two main groups: polyether diols and polyester diols. The polyether diols are based, for example, on polytetrahydrofuran, polyethylene oxide and polypropylene oxide, and mixtures thereof. The polyester diols are typically based on adipates, for example butane-1,4-diol adipate and hexane-1,6-diol adipate and caprolactone. Cocondensates are likewise possible.

In the preparation of the TPUs, it is possible to use catalysts that are customary and known in the art. These may be tertiary amines, for example triethylamine, dimethylcyclohexylamine, N-methylmorpholine, N,N′-dimethylpiperazine, 2-(dimethylaminoethoxy)ethanol, diazabicyclo[2.2.2]octane and the like and also in particular organic metal compounds such as titanic esters, iron compounds or tin compounds such as tin diacetate, tin dioctoate, tin dilaurate or the dialkyltin salts of aliphatic carboxylic acids, for example dibutyltin diacetate or dibutyltin dilaurate or the like. Preferred catalysts are organic metal compounds, especially titanic esters, iron compounds and tin compounds. The total amount of catalysts in the TPUs may generally be about 0% to 5% by weight, preferably 0% to 2% by weight, based on the total amount of TPUs.

In addition, the TPUs may contain auxiliaries and additives up to a maximum of 20% by weight, based on the total amount of TPUs. Typical auxiliaries and additives are pigments, dyes, flame retardants, stabilizers against aging and weathering effects, plasticizers, lubricants and demolding agents, fungistats and bacteriostats and fillers, and mixtures thereof.

Examples of further additives are lubricants, such as fatty acid esters, metal soaps thereof, fatty acid amides, fatty acid ester amides and silicone compounds, antiblocking agents, inhibitors, stabilizers against hydrolysis, light, heat and discoloration, flame retardants, dyes, pigments, inorganic and/or organic fillers, for example polycarbonates, and plasticizers and reinforcers. Reinforcers are especially fibrous reinforcing materials, for example inorganic fibers which are produced according to the prior art and may also have been sized. Further details on the auxiliaries and additives mentioned can be found in the specialist literature, for example in the monograph by J. H. Saunders and K. C. Frisch “High Polymers”, volume XVI, Polyurethane [Polyurethanes], parts 1 and 2, Interscience Publishers 1962 and 1964, in “Taschenbuch für Kunststoff-Additive” [Plastics Additives Handbook] by R. Gächter and H. Müller (Hamer Verlag Munich 1990) or in DE-A 29 01 774.

For production of the foam layer b) of the invention, a blowing agent is added to the TPU, preferably a blowing agent that eliminates CO₂ when heated and hence forms the foam layer. Suitable blowing agents are hydrogencarbonates, for example calcium hydrogencarbonate, potassium hydrogencarbonate and/or sodium hydrogencarbonate, and/or citrates, for example sodium citrate, potassium citrate, calcium citrate, magnesium citrate.

For production of the foam layer b), the granular TPU is typically mixed in the form of a masterbatch containing a blowing agent. This mixture is then compressed, melted and homogenized in an extruder. The temperatures of the melt in the extruder are above the breakdown temperature of the blowing agent and CO₂ is eliminated, which dissolves for the most part in the melt under the existing pressure. The melt is guided through an extrusion tool, which is also referred to as die. The pressure drop on exit from the die results in release of the CO₂ dissolved in the melt, which produces finely distributed bubbles. This foamed melt web can be processed to give a foamed film by means of further processing by the flat film or blown film method.

In both methods, further layers comprising at least one thermoplastic, preferably TPU, may be co-extruded with or without blowing agents.

Suitable thermoplastic polyurethanes are available on the market, for example, under the Desmopan™ Elastollan™, Pellethane™, Estane™, Morthane™ or Texin™ trade names.

In one embodiment of the invention, the laminate comprises one or more further layers c) comprising at least one TPU having a total layer thickness of the one or more further layers c) of ≥5 μm to ≤150 μm, preferably of ≥10 μm to ≤120 μm, more preferably of ≥15 μm to ≤110 μm, and wherein the one or more further layers c) are arranged such that the layers form the direct sequence a) c) b) or a) b) c). Particular preference is given to using layer c) in the form of a film.

In a preferred embodiment of the invention, one or more further layers c) comprising at least one TPU having a total layer thickness of the one or more further layers c) of ≥5 μm to ≤150 μm, preferably of ≥10 μm to ≤120 μm, more preferably of ≥15 μm to ≤110 μm, is arranged in such a way that the at least one component and/or functional unit (A) is at least partly covered by the one or more further layers c), i.e. the layers form the direct sequence a) c) b).

For avoidance of repetition, the above-described TPUs are also applicable to the one or more further layers c) with the aforementioned embodiments and areas of preference.

In a further embodiment, the laminate comprises one or more further layers d) comprising at least one TPU having a total layer thickness of the one or more layers d) of ≥5 μm to ≤150 μm, preferably of ≥10 μm to ≤120 μm, more preferably of ≥15 μm to ≤110 μm, and wherein these one or more further layers d) are arranged in the laminate in such a way that layer b) is always between the at least one further layer d) and the at least one further layer c), the layers preferably being arranged in the direct sequence a) c) b) d) or a) d) b) c).

In another embodiment of the invention, the one or more layers d) may be used in the form of a single-layer or multilayer film.

In a further embodiment, the TPU of the one or more further layers c) and/or of the one or more further layers d) in each case has a hardness of ≥60 Shore A to DIN ISO 7619-1 to ≤60 Shore D to DIN ISO 7619-1, preferably of ≥70 Shore A to DIN ISO 7619-1 to ≤95 Shore A to DIN ISO 7619-1, most preferably of ≥80 Shore A to DIN ISO 7619-1 to ≤95 Shore A to DIN ISO 7619-1.

The at least one TPU of layer c) may be identical to or different than the at least one TPU of layer d); preferably, the at least one TPU of layer c) and of layer d) is the same.

For avoidance of repetition, the above-described thermoplastics, especially the above-described TPUs, are also applicable to the one or more layers d) with the aforementioned embodiments and areas of preference.

In one embodiment of the invention, the at least one layer b) and the one or more layers c) are present in the laminate in the form of a multilayer film b) c), preferably of a multilayer co-extruded film b) c).

In another embodiment, the at least one layer b), the one or more layers c) and the one or more layers d) are present in the laminate in the form of a multilayer film c) b) d), wherein the one or more layers c) and d) surround the at least one layer b), preferably of a multilayer co-extruded film c) b) d).

The thermoplastic polyurethanes usable in accordance with the invention in the one or more layers c) and/or the one or more layers d) may be produced continuously by what is called the extruder method, for example in a multi-shaft extruder, or by what is called the belt method. The above-described TPUs, optionally with the above-described auxiliaries and additives, can be dosed simultaneously, i.e. in the one-shot method, or successively, i.e. by a prepolymer method. Particular preference is given to the prepolymer method. The prepolymer here can either be initially charged batchwise or produced continuously in a portion of the extruder or in a separate upstream prepolymer unit, for example a static mixer reactor, e.g. Sulzer mixer. Layers c) and d) may comprise identical or different TPU components of those described above; these TPU components are preferably the same.

The inventive TPU layers c) and/or d) of the laminate of the invention can be produced by melting the TPU granules of the invention in a melting extruder and extruding them through a die to give a film in a thickness of ≥5 μm to ≤150 μm, preferably of ≥10 μm to ≤120 μm, more preferably of ≥15 μm to ≤110 μm.

The production of layers b), c) and/or d) can be produced by the methods known to the person skilled in the art: the melt extrusion method, the blown extrusion method and/or the cast extrusion method. For this purpose, the corresponding above-described TPU granules of the individual layers are melted in a melting extruder and extruded through a die to give a film in appropriate layer thicknesses.

In the laminate of the invention, layers b), optionally c) and optionally d) prior to lamination may have a total layer thickness of ≥100 to ≤1200 μm, preferably of ≥300 to ≤800 μm, more preferably of ≥350 to ≤550 μm. More particularly, the thickness of layer b) may be chosen such that said layer b) fully encases the component and/or the functional unit (A). Preferably, the laminate after the lamination process has at least one, preferably two, of the following properties:
a. a thickness after lamination within a range from ≥80 to ≤3000 μm, preferably from ≥200 to ≤1500 μm, more preferably from ≥350 to ≤1000 μm, most preferably from ≥400 to ≤800 μm;
b. a difference in thickness at the thinnest point in the laminate compared to the thickest point in the laminate over the total length of the laminate preferably within a range from 1 to 150 μm, more preferably within a range from 2 to 100 μm, especially preferably within a range from 5 to 80 μm, most preferably from 10 to 70 μm;
c. a difference in thickness at the thinnest point in the laminate compared to the thickest point in the laminate over the total width of the laminate preferably within a range from 1 to 150 μm, more preferably within a range from 2 to 100 μm, especially preferably within a range from 5 to 80 μm, most preferably from 10 to 70 μm.

More particularly, the thickness of layer b) may be chosen such that layer b) especially surrounds the component and/or the functional unit (A) on the sides that are not in contact with layer a). More particularly, the thickness of layer b) may be chosen such that layer b) surrounds the component and/or the functional unit (A) on all sides in two spatial directions.

In a preferred configuration of the laminate, the layer(s) is/are transparent above the component or the functional unit (A). This is preferably achieved in that, in the lamination of the layers, the foam layer in particular is preferably pressed onto the component and/or the functional unit (A) with such intensity that the foam breaks down and gives rise to a transparent structure. In this way, it can be made possible to see surface structures of the component or the functional unit (A) through the original foam layer, the foam of which has broken down.

The at least one TPU in layers b), c) and/or d) is preferably the same.

The laminate may comprise one or more further layers e) of a thermoplastic and/or thermoset, preferably thermoplastic. With regard to the thermoplastic or thermoset, reference is made to the materials, embodiments and areas of preference specified for layer a).

These further layers e) may be positioned on either side of the above-described laminate of the invention. The following layer sequences may be possible:

e)-a)-b)
a)-b)-e)
e)-a)-b)-e)
e)-a)-b)-c)
e)-a)-c)-b)
e)-a)-b)-c)-e)
e)-a)-c)-b)-e)
a)-b)-c)-e)
a)-c)-b)-e)
e)-a)-d)-b)-c)
e)-a)-c)-b)-d)
e)-a)-d)-b)-c)-e)
e)-a)-c)-b)-d)-e)
a)-d)-b)-c)-e)
a)-c)-b)-d)-e)

The invention further provides a process for producing the laminate of the invention, comprising the steps of:
i) providing a layer a) containing at least one thermoplastic and/or thermoset, preferably a thermoplastic,
ii) positioning at least one component and/or functional unit (A) on the surface of the layer a),
iii) positioning at least one layer b) containing at least one thermoplastic polyurethane and in the form of a foam layer at least in some regions, in such a way that at least regions of the at least one component and/or one functional unit (A) thereof are surrounded or the at least one component and/or one functional unit is fully encased by the at least one layer b), preferably fully encased,
iv) laminating the layers from steps i) to iii) at a temperature of ≥80° C. to ≤220° C., preferably of ≥100° C. to ≤200° C., most preferably of ≥110° C. to ≤190° C., and a pressure of ≥2 N/cm² to ≤400 N/cm², preferably of ≥5 N/cm² to ≤350 N/cm², most preferably of ≥10 N/cm² to ≤300 N/cm².

In a first embodiment of the process of the invention, one or more further layers c) comprising at least one thermoplastic polyurethane having a total layer thickness of the one or more layers c) of ≥5 μm to ≤150 μm, preferably of ≥10 μm to ≤120 μm, more preferably of ≥15 μm to ≤110 μm, is positioned in such a way that these one or more further layers c) are placed onto the surface of the layer sequence either before step iii) or after step iii), the layers preferably being arranged in the direct sequence a) b) c) or a) c) b).

In a preferred embodiment of the first embodiment, layers b) and c) are used in the form of a two-layer film.

In a second embodiment of the process of the invention, as well as the further layer c), one or more further layers d) comprising at least one thermoplastic polyurethane having a total layer thickness of ≥5 μm to ≤150 μm, preferably of ≥10 μm to ≤120 μm, more preferably of ≥15 μm to ≤110 μm, is positioned in such a way that layer b) is always between the one or more further layers d) and the one or more further layers c), the layers preferably being arranged in the direct sequence a) c) b) d) or a) d) b) c).

In a preferred embodiment of the second embodiment, layers b), c) and d) are used in the form of a multilayer film, wherein layer b) constitutes the middle layer of this multilayer film, this multilayer film preferably having the sequence c) b) d) or d) b) c).

In a further embodiment of the process of the invention, one or more further layers e) comprising at least one thermoplastic and/or thermoset, preferably thermoplastic, may be positioned before step i) and/or after step iii) in such a way that these one or more further layers e) are laid over at least part of the surface of the corresponding layers from steps i) and/or iii). A further layer e) may also be present in the above first and/or second embodiments, and preferred embodiments thereof.

In respect of the individual layers a), b), c), d) and/or e), reference is made to the above-described materials, embodiments and arrangements.

The laminate of the invention may go into various applications, for example security documents, especially identification cards, chip cards, also called smartcards. In addition, the laminates of the invention may find use in electronic products for everyday use. These are, for example, thin two-dimensional structures that accommodate sensitive electronic components, for example labels incorporating near-field communication (NFC) modules, particularly thin and flexible mobile phones, smart watches, flexible displays, flexible solar modules, flexible batteries.

The invention therefore further provides security documents, chip cards, smartphones, tablets, displays for smartphones and/or displays for tablets, comprising at least one laminate of the invention.

### EXAMPLES

### Example 1: Production of a Thermoplastic Multilayer Foam Film of Layer Sequence c)b)c)

A multilayer thermoplastic polyurethane film having a thickness of 600 μm was produced by the blown film method. The film consisted of three layers: the two outer layers c) each composed of 100 μm of compact thermoplastic polyurethane and the 400 μm-thick middle layer b) of foamed thermoplastic polyurethane. The thermoplastic polyurethane used was a TPU based on polytetrahydrofuran (molecular weight 2000), methylene diphenylene 4,4′-diisocyanate and butane-1,4-diol as chain extender with a Shore A hardness of 87, measured to DIN ISO 7619-1, corresponding to a Shore D hardness of 36, measured to DIN ISO 7619-1, a density of 1.12 g/cm³ measured to DIN EN ISO 1183-1A and a melt flow index (MFI) of 30 g/10 min measured at 190° C./21.6 kg (DIN ISO 1133). For the foaming of the middle layer, 5% by weight of Hydrocerol™ CF20 from Clariant was added to the TPU, which releases CO₂ in the course of heating of the film in the extruder and hence foams the TPU on exit from the die. This foam film had a thickness of 600 μm.

### Example 2: Production of the Film Stack for the Laminate of the Invention

FIG. 1 shows a schematic of the sequence of the layers of the film stack of example 2. Positioned atop a film of Makrolon™ 3108 polycarbonate of thickness 100 μm (identified in FIG. 1 as a)) at a distance of 30 mm were three high-temperature-resistant plastic components each of thickness 100 μm (identified in FIG. 1 as (A-3)), 200 μm (identified in FIG. 1 as (A-2)) and 300 μm (identified in FIG. 1 as (A-1)). It is possible here for the 200 μm-thick plastic component A-2 to be composed of two layers of the 100 μm-thick plastic component A-3; correspondingly, the plastic component A-1 may also be composed of three layers of the plastic component A-3.

The foam film from example 1 (identified in FIG. 1 as b)) was positioned above this polycarbonate film with components A-1, A-2 and A-3.

A further film of Makrolon™ 3108 polycarbonate of thickness 100 μm (identified in FIG. 1 as a)) was positioned above the foam film.

### Example 3: Production of the Laminate

The film stack from example 2 was laminated on a Bürkle lamination press with the following parameters:

preheating the press to 175° C.
pressing for 3 minutes at a pressure of 50 N/cm²
cooling the press to 38° C. and opening the press.

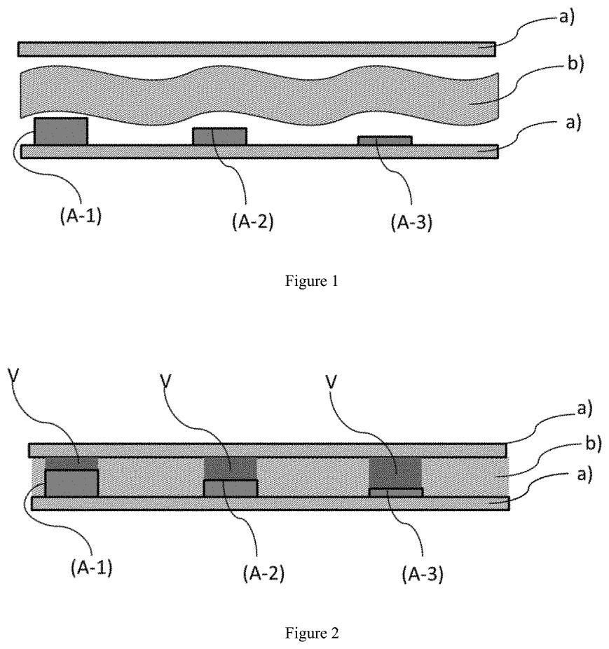

The laminate showed homogeneous embedding of the components in all heights, 100 μm, 200 μm and 300 μm, without faults in the flow profile, or without any perturbation in the composition of components A-1 and A-2 when they are composed of multiple plastic components. The foam was more significantly compressed directly above components A-1 and A-2. The surface of the laminate was flat, “flat” meaning that a micrometer that can measure 0.1 μm as the smallest measurement unit cannot ascertain any difference in thickness. In FIG. 2, V means compressed foam.

### Comparative Example 4

A film stack was produced according to example 2, except that the film according to example 1 (layer b) of FIG. 1) was replaced by a thermoplastic polyurethane film of thickness 640 μm that was produced by blown film extrusion. The thermoplastic polyurethane used was a TPU based on polytetrahydrofuran (molecular weight 2000 g/mol), methylene diphenylene 4,4′-diisocyanate and butane-1,4-diol as chain extender with a Shore A hardness of 87, measured to DIN ISO 7619-1, corresponding to a Shore D hardness of 36, measured to DIN ISO 7619-1, a density measured to DIN EN ISO 1183-1A of 1.12 g/cm³ and a melt flow index (MFI) of 30 g/10 min measured at 190° C./21.6 kg (to DIN ISO 1133).

The film stack of comparative example 4 was laminated according to example 3.

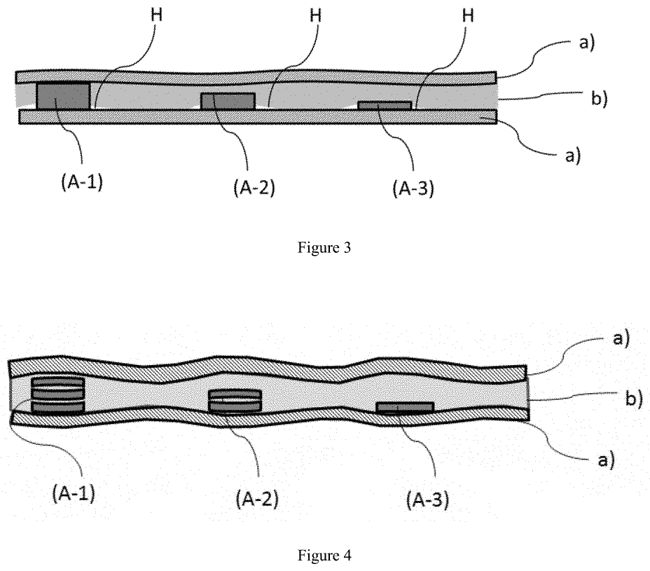

The laminate from comparative example 4 showed inhomogeneous embedding of the components in all heights, 100, 200 and 300 μm, with faults in the flow profile, which was manifested in a perturbation of the composition of components A-2 and A-3 (schematic view in FIG. 3). The laminate of comparative example 4 did not show a flat surface and, moreover, cavities are apparent adjacent to components A-1, A-2 and A-3. In FIG. 3, H means cavity.

In a further comparative example 4, as shown in FIG. 4, the laminate bulged at the sites of embedding of components A-1, A-2 and A-3, by comparison to the spaces between the components. The difference in height of the laminate measured over the complete surface of the top face was about 55 μm. The difference in height of the laminate measured over the complete surface of the bottom face of the laminate was likewise about 52 μm. The laminate thus had a difference in thickness between its thinnest and its thickest site of about 107 μm.

Example 3 and comparative example 4 show clearly that, in the laminate of the invention, the components could be embedded in the laminate without faults. In addition, the components were firmly embedded in the laminate of the invention, without any damage to the components in the laminating operation. The surface of the laminates of the invention is flat, whereas the surface of the comparative laminate had a wavy structure.

Reference numerals of FIGS. 1 to 3:

(A-1) High-temperature-resistant plastic component of thickness 300 μm
(A-2) High-temperature-resistant plastic component of thickness 200 μm
(A-3) High-temperature-resistant plastic component of thickness 100 μm
a) Film of Makrolon™ 3108 polycarbonate of thickness 100 μm
b) Film from example 1 or film from comparative example 4

### H) Cavity

V) Compressed foam

1. A laminate comprising
at least one layer a) containing at least one thermoplastic and/or thermoset,
at least one layer b) containing at least one thermoplastic polyurethane,
wherein at least one component and/or functional unit (A) is positioned on the at least one layer a), and
wherein the at least one thermoplastic polyurethane of layer b) takes the form of a foam layer at least in some regions.

2. The laminate as claimed in claim 1, wherein at least some regions of the component and/or the functional unit (A) are surrounded by the at least one layer b), or the component and/or the functional unit (A) is fully encased by the at least one layer b).

3. The laminate as claimed in claim 1, wherein the at least one thermoplastic polyurethane of layer b) has a hardness of ≥60 Shore A according to DIN ISO 7619-1 to ≥60 Shore D according to DIN ISO 7619-1.

4. The laminate as claimed in claim 1, further comprising one or more layers c) comprising at least one thermoplastic polyurethane, wherein a total layer thickness of the one or more layers c) of is from ≥5 μm to ≤150 μm, and wherein the one or more layers c) are arranged such that the one or more layers c) are positioned between the at least one layer a) and the at least one layer b) or the at least one layer b is positioned between the at least one layer a) and the one or more layers c).

5. The laminate as claimed in claim 4, further comprising one or more layers d) comprising at least one thermoplastic polyurethane, wherein a total layer thickness of the one or more layers d) is from ≥5 μm to ≤150 μm, and wherein the one or more layers d) are disposed in the laminate in such a way that layer b) is always between the one or more layers d) and the one or more layers c).

6. The laminate as claimed in claim 5, wherein the at least one thermoplastic polyurethane of the one or more layers c) and/or of the one or more layers d) has a hardness in each case of ≥60 Shore A according to DIN ISO 7619-1 to ≥60 Shore D according to DIN ISO 7619-1.

7. The laminate as claimed in claim 1, wherein the at least one layer a) comprises at least one thermoplastic selected from the group consisting of one or more polycarbonate(s) or copolycarbonate(s) based on diphenols, poly- or copolyacrylates, poly- or copolymethacrylate(s), poly- or copolymer(s) with styrene, acrylonitrile-butadiene-styrene, or polystyrene-acrylonitrile, thermoplastic polyurethane(s), polyolefin(s), poly- or copolycondensate(s) of an aromatic dicarboxylic acid and aliphatic, cycloaliphatic and/or araliphatic diols having 2 to 16 carbon atoms, polyamide, poly- or copolycondensate(s) of at least one cycloalkyldicarboxylic acid, polysulfones, polyvinyl halides, mixtures thereof, and blends of at least two of the above.

8. The laminate as claimed in claim 1, wherein layers b), optionally one or more layers c) and optionally one or more layers d) prior to lamination have a total thickness of ≥100 to ≤1200 μm, and wherein the laminate comprises one or more of the following properties:
a. a thickness after lamination within a range from ≥80 to ≤3000 μm;
b. a difference in thickness at a thinnest point in the laminate compared to a thickest point in the laminate over a total length of the laminate within a range from 1 to 150 μm; or
c. a difference in thickness at the thinnest point in the laminate compared to the thickest point in the laminate over a total width of the laminate within a range from 1 to 150 μm.

9. A process for producing a laminate as claimed in claim 1, comprising
i) providing a layer a) containing at least one thermoplastic and/or thermoset;
ii) positioning at least one component and/or functional unit (A) on a surface of the layer a);
iii) positioning at least one layer b) to surround at least some regions of the at least one component and/or functional unit (A) or to fully encase the at least one component and/or functional unit (A), wherein the at least one layer b comprises at least one thermoplastic polyurethane and forms a foam layer in at least some regions; and
iv) laminating the layers from steps i) to iii) at a temperature of ≥80° C. to ≤220° C. and at a pressure of ≥2 N/cm² to ≤400 N/cm².

10. The process as claimed in claim 9, further comprising positioning one or more layers c) onto a surface of the layer sequence either before step iii) or after step iii), wherein the one or more layers c) comprise at least one thermoplastic polyurethane and have a total layer thickness of from ≥5 μm to ≤150 μm.

11. The process as claimed in claim 10, further comprising positioning one or more layers d) such that layer b) is always between the one or more layers d) and the one or more layers c), wherein the one or more layers d) comprise at least one thermoplastic polyurethane and have a total layer thickness of from ≥5 μm to ≤150 μm.

12. The process as claimed in claim 10, wherein layers b) and c) are positioned correspondingly in step iii) to form a multilayer thermoplastic polyurethane film.

13. The process as claimed in claim 11, wherein layers b), c) and d) are positioned correspondingly in step iii) to form a multilayer thermoplastic polyurethane film.

14. The process as claimed in claim 9, further comprising positioning one or more layers e), before step i) and/or after step iii), to contact at least part of a surface of corresponding layers from steps i) and/or iii), wherein the one or more layers e) comprise at least one thermoplastic and/or thermoset.

15. A security document, chip card, smartphone, tablet, display for a smartphone, display for a tablet, or a combination thereof comprising at least one laminate as claimed in claim 1.

16. The laminate as claimed in claim 4, wherein the at least one thermoplastic polyurethane of the one or more layers c) has a hardness of ≥60 Shore A according to DIN ISO 7619-1 to ≤60 Shore D according to DIN ISO 7619-1.

17. The process as claimed in claim 12, wherein the multilayer thermoplastic polyurethane film is arranged in a direct sequence of a) b) c) or a) c) b).

18. The process as claimed in claim 13, wherein the multilayer thermoplastic polyurethane film is arranged in a direct sequence of a) c) b) d) or a) d) b) c).
